(19) United States
(12) Patent Application Publication
(10) Pub. No.: US 2009/0294295 A1
(43) Pub. Date: Dec. 3, 2009

(54) METHOD FOR FORMING COMPOSITE PLATING FILM AND PROCESS FOR MANUFACTURING INKJET RECORDING HEAD

(75) Inventor: Hiroki UCHIYAMA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/473,732

(22) Filed: May 28, 2009

(30) Foreign Application Priority Data
Jun. 3, 2008 (JP) 2008-146112

(51) Int. Cl. C25D 5/02; B05D 3/00; B05D 1/18; C25D 7/00

(52) U.S. Cl. 205/127; 427/154; 427/430.1

(57) ABSTRACT

A mixed fluid obtained by mixing and stirring a high pressure fluid and a plating solution containing fine particles is contacted with a body to be plated to form a composite plating film. When an inkjet recording head is manufactured, a protective film 14 for plating is formed on a surface on a side opposite to an ink jet side of a nozzle plate 11 and, preferably, a mixed fluid obtained by mixing and stirring supercritical carbon dioxide, and a plating solution containing liquid repellent fine particles and a surfactant is contacted with a nozzle plate to form a composite plating film 16 on a surface on an ink jet side. After plating, the protective film for plating is removed from the nozzle plate.

### CROSS REFERENCE TO RELATED APPLICATION

This application claims priority under 35USC 119 from Japanese Patent Application No. 2008-146112, the disclosure of which is incorporated herein by reference.

### BACKGROUND OF THE INVENTION

1. Field of the Invention

The present invention relates to a method for forming a composite plating film and a process for manufacturing an inkjet recording head and, more particularly, relates to a method for forming a composite plating film and a process for manufacturing an inkjet recording head using a supercritical fluid and the like.

2. Description of the Related Art

In an inkjet recording apparatus, a representative of which is an inkjet printer, an ink droplet is flown through an ink jet port of an inkjet recording head to form an image on a recording medium. A surface having the ink jet port (ink jet surface) is formed of, for example, a metal, a ceramics, silicon, a glass or a plastic, and the ink jet surface is required to have liquid repellency (water repellency when a water-based ink is used, and oil repellency when an oil-based ink is used) in order to jet an ink droplet to a predetermined position.

When liquid repellency of the ink jet surface 3 is insufficient, or not uniform, ink is adhered to a vicinity of a jet port when the ink is jetted, and a non-uniform ink stagnation 5a is easily generated as shown in FIG. 7A. Then, when the ink 5 is jetted again, its jet direction is pulled towards the ink stagnation 5a side as shown in FIG. 7B, and is turned aside from a normal jet direction. Further, when a whole circumference of the jet port 2 is covered with an ink film, a splash phenomenon (scattering of ink) is generated and, further, by growth of a liquid stagnation covering the jet port 2, jetting of a droplet from a recording head becomes impossible in some cases.

When a paper powder generated from a recording paper, a dust and a foreign matter in the air in addition to a remaining ink are adhered to the ink jet surface, an operation of rubbing a surface having the ink jet port 2 with a rubber blade 7 (i.e. wiping) is performed as shown in FIG. 8 in a general inkjet printer, for the purpose of preventing clogging of the jet port 2 or performing normal jetting. However, when adhesion of a surface treatment layer 6 provided for imparting liquid repellency to the ink jet surface is weak, if wiping is conducted some times, the surface treatment layer 6 is peeled off, and liquid repellency is gradually lost. Then, when an ink 5 is jetted from an inkjet recording head, the ink 5 adheres to the vicinity of the jet port, and a flying direction of the ink 5 is pulled towards the ink adhesion side, and flying deflection is generated. In addition, a problem arises that when a periphery of the jet port 2 is rubbed with a material to be recorded such as a paper rarely, a water repellency treatment film is peeled off, and the function is not exerted.

From such a problem, generally, a nozzle plate 1 used in an inkjet printer head is required to stably jet an ink droplet, to prevent adhesion of a remaining ink to the surrounding of a nozzle aperture after jetting, further, to be chemically stable to a aqueous or non-aqueous ink, and to have the high mechanical strength such as excellent abrasion resistance.

For such requirements, for example, an inkjet recording head provided with a liquid repellent film formed by codeposition plating of a fluorine resin-metal is known. By providing a plating film obtained by codepositing a fluorine resin fine particle, a representative of which is Teflon (registered trade mark) on an ink jet surface, improvement in liquid repellency, mechanical strength, and chemical stability is attempted (see e.g. Japanese Patent Application Laid-Open (JP-A) Nos. 7-138763, 7-246707, 11-58746, and 11-91090).

However, a plating film obtained by codepositing the fluorine resin fine particles does not sufficiently satisfy the condition required for a nozzle plate of the inkjet printer head. For example, when ultrasonic cleaning is performed in a cleaning step in a process of assembling a head, the fluorine resin fine particles exposed on a plating surface fall off by impact of an ultrasound, or when a surface of the nozzle plate is wiped many times, phenomenon is observed that the fluorine resin fine particles of a top surface fall off, and liquid repellency is reduced. In addition, there is also a problem that, since the dispersing state of the fluorine resin fine particles in the plating film is not uniform, accompanying with deterioration of the plating film, the existence amount of the fluorine resin fine particles in the top surface is different, and constant liquid repellency cannot be maintained.

Further, a pinhole derived from hydrogen generated by a plating reaction causes adsorption of an ink or a foreign matter, and a void generated at an interface between a substrate and the plating film reduces adhesion, and this becomes a cause for peeling of the plating film by wiping.

In addition, upon a plating step, a nodule (node-like deposit) is randomly generated on a surface of the plating film and, when the nodule is formed particularly around the ink jet port, jetting of an ink droplet becomes unstable, and phenomenon that a jet direction of the ink droplet is turned aside is easily generated.

In addition, this is limited to the inkjet recording head, and upon formation of a composite plating film on a surface of a body to be plated by mixing fine particles in order to impart the particular function to a plating solution, when the body to be plated has a fine structure, it is difficult to uniformly disperse the fine particles in the plating film, and there is a problem in that uneven distribution of functional fine particles in the plating film, and generation of a pinhole, void or nodule is liable to causes a functional problem.

### SUMMARY OF THE INVENTION

The present invention has been made in view of the above circumstances and provides a method for forming a composite plating film and a process for manufacturing an inkjet recording head as described bellow.

According to a first aspect of the invention, a method for forming a composite plating film, including: contacting a mixed fluid obtained by mixing and stirring a high pressure fluid and a plating solution containing fine particles, with a body to be plated to form a composite plating film, is provided.

According to a second aspect of the invention, a process for manufacturing an inkjet recording head, including:

forming a protective film for plating on a surface on a side opposite to an ink jet side of a nozzle plate in which a nozzle part for jetting an ink has been formed, contacting a mixed fluid obtained by mixing and stirring a first high pressure fluid and a plating solution containing liquid repellent fine particles with the nozzle plate on which the protective film for plating is formed to form a composite plating film on a surface on the ink jet side, and

removing the protective film for plating from the nozzle plate on which the composite plating film is formed.

### BRIEF DESCRIPTION OF THE DRAWINGS

FIG. 1 is a state diagram showing a supercritical fluid and a subcritical region.

FIG. 2 is a view showing one example of a step of forming a composite plating film upon manufacturing of an inkjet recording head by the invention.

FIG. 3 is a schematic view showing one example of the state of a nozzle plate in each step before and after plating.

FIG. 4 is a schematic view showing one example of a structure of a supercritical fluid apparatus which may be used in the invention.

FIG. 5 is a schematic view showing the state of a pressure fluid and a plating solution in electroless plating.

FIG. 6 is a schematic view showing the state of a high pressure fluid and a plating solution in electroplating.

FIG. 7A is a schematic view showing phenomenon (ink stagnation) generated in a conventional inkjet recording head.

FIG. 7B is a schematic view showing phenomenon (deflection of an inkjet direction) generated in a conventional inkjet recording head.

FIG. 8 is a schematic view showing wiping of an ink jet port.

### DETAILED DESCRIPTION OF THE INVENTION

The present invention will be specifically explained below referring to attached drawings. The shape, the size and arrangement relationship of each constituent part are merely schematically shown to such an extent that the invention can be understood, and the invention is not particularly limited by this.

The invention has a step of contacting a mixed fluid obtained by mixing a high pressure fluid and a plating solution containing fine particles, and stirring the mixture, with a body to be plated, to form a composite plating film.

<High Pressure Fluid>

The “high pressure fluid” in the invention means typically a fluid containing a supercritical fluid or a subcritical fluid.

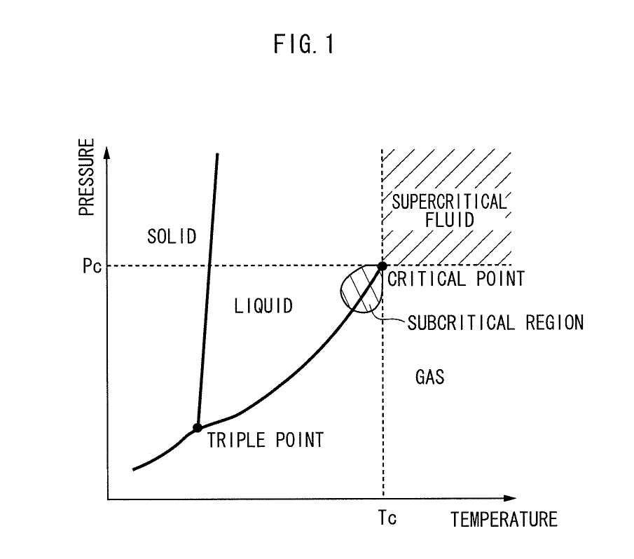

FIG. 1 is a state diagram of a pure substance. As shown in FIG. 1, the supercritical fluid is a high pressure fluid in a state where the conditions of the pressure and the temperature are P>Pc (critical pressure), and T>Tc (critical temperature) at the vicinity of a critical point. For example, in the case of carbon dioxide, the critical temperature is 304.5 K, and the critical pressure is 7.387 MPa, and in a state where temperature and pressure are both greater than the critical temperature and the critical pressure, the carbon dioxide becomes a supercritical fluid (supercritical carbon dioxide).

On the other hand, the subcritical fluid refers to a fluid which is in a region in a vicinity before the critical point, and the subcritical fluid is in a state where the compressed liquid and the compressed gas coexist. A fluid in this region is distinguished from the supercritical fluid, but since the physical properties such as the density are continuously changed, there is no physical border, and the subcritical fluid in such a region may also be used as the high pressure fluid in the invention. In addition, a fluid in such a subcritical region and supercritical region near the critical point is also called a high density liquefied gas.

The kind of the high pressure fluid used in the invention is not particularly limited, but a suitable supercritical or subcritical fluid may be selected, depending on the plating solution used, and the kind of fine particles. Examples of the high pressure fluid include carbon dioxide, oxygen, argon, krypton, xenon, ammonia, methane trifluoride, ethane, propane, butane, benzene, methyl ether, chloroform, water, and ethanol. Among them, from a view point of a practical critical point, environmental adaptability, and non-toxicity, it is preferable to use the supercritical fluid of carbon dioxide.

<Plating Solution>

As the plating solution, a plating solution containing fine particles having the property depending on the purpose of the composite plating film to be formed, preferably a plating solution further containing a surfactant which promotes mixing with the high pressure fluid is used.

In addition, a metal matrix of the plating film is not particularly limited, and may be selected from, for example, metals such as nickel, copper, silver, zinc, and tin, and alloys thereof. Due to excellent surface hardness and abrasion resistance, preferably, nickel (Ni) or a nickel alloy such as a nickel-cobalt alloy (Ni—Co), a nickel-phosphorus alloy (N—P), and a nickel-boron alloy (Ni—B) is selected.

As an electrolyte solution which is to be a plating solution, solutions in which one or more kinds of electrolytes such as metallic salts, organic electrolytes, acids such as phosphoric acid, and alkali substances are dissolved in a solvent are used.

The solvent is not particularly limited as far as it is a polar solvent, and examples include water, alcohols such as ethanol and methanol, cyclic carbonates such as ethylene carbonate, and propylene carbonate, straight carbonates such as dimethyl carbonate, ethyl methyl carbonate, and diethyl carbonate, and mixed solvents thereof.

The metal salts may be appropriately selected in view of the kind of a metal, an alloy, and an oxide to be deposited as the plating film. Examples of a metal which may be electrochemically deposited include Cu, Zn, Ga, As, Cr, Se, Mn, Fe, Co, Ni, Ag, Cd, In, Sn, Sb, Te, Ru, Rh, Pd, Au, Hg, Tl, Pb, Bi, W, Po, Re, Os, Ir, and Pt.

Examples of the organic electrolyte include anionic electrolytes such as polyacrylic acid, and cationic electrolytes such as polyethyleneimine, but are not limited thereto.

The electrolyte solution which is to be a plating solution may contain one or more kinds of substances, in addition to the aforementioned substances, for the purpose of stabilizing the solution. Specifically, examples include (1) a substance which forms a complex salt with an ion of a metal to be deposited, (2) an indifferent salt for improving electrical conductivity of the electrolyte solution, (3) a stabilizer for the electrolyte solution, (4) a buffer of the electrolyte solution, (5) a substance which changes the physical property of a deposited metal, (6) a substance which assists dissolution of a cathode, (7) a substance which changes the property of the electrolyte solution, or the property of a deposited metal, and (8) a stabilizer for a mixed solution containing two or more kinds of metals.

For example, when the composite plating film is formed by an electroless plating method, generally, an electroless plating solution containing metal salts, complexing agents, and reducing agents is used.

Examples of the metal which may be used in the electroless plating solution include V, Cr, Mo, W, Mn, Re, Fe, Ru, Co, Rh, Ni, Pd, Pt, Cu, Ag, Au, Cd, B, In, Ti, Sn, Pb, P, As, Sb, and Bi.

Examples of the complexing agent include organic acids such as dicarboxylic acids such as succinic acid, oxycarboxylic acids such as citric acid and tartaric acid, and aminoacetic acids such as glycine and EDTA, and sodium salts thereof.

Examples of the reducing agent include sodium hypophosphite, sodium phosphite, formaldehyde, sodium borohydride, potassium borohydride, dimethylamineborane, and hydrazine.

<Fine Particle>

As the fine particles contained in the plating solution, organic or inorganic fine particles may be selected depending on properties to be imparted to the plating film.

For example, when abrasion resistance, heat resistance, or the like is imparted, inorganic fine particles made of silicon dioxide, alumina, zirconia, tungsten oxide, titanium dioxide, silicon carbide, or the like may be used.

When self lubricating property is imparted, fine particles made of molybdenum dioxide, graphite, boron nitride, graphite fluoride, polymeric fluorine compound, or the like may be used.

When lubricating property, liquid repellency or the like is imparted, fine particles made of graphite fluoride, fluorine resin, or the like may be used.

When hydrophilicity is imparted, fine particles made of hydrophilic PTFE (polytetrafluoroethylene) or the like may be used.

The size of the fine particles to be added to the plating solution is not particularly limited, and it may be selected depending on use of a body to be plated, the purpose of a plating film, and the like. However, when the particle diameter is too small, aggregation of particles is liable to be caused and, on the other hand, when it is too large, the surface roughness of the plating film is liable to be increased. The fine particles each having the maximum diameter of usually a few tens nm to a few tens μm, more preferably around 0.1 μm to 1 μm are used. For example, when the composite plating film is formed on a fine structure such as a semiconductor and MEMS (Micro Electro Mechanical Systems), the fine particles each having the maximum diameter of a few nm to a few hundreds nm may be suitably used.

In addition, for example, when plural functions are imparted to the plating film, two or more kinds of the fine particles may be added to the plating solution, if necessary.

-Fluorine-Based Resin Fine Particle-

For example, when liquid repellency is imparted to the ink jet surface of the inkjet head nozzle plate, it is preferable to use a codeposition plating solution of fluororesin-metal. As the fluororesin to be codeposited, the known fluororesins may be widely used. Specifically, examples include PTFE (polytetrafluoroethylene), FEP (perfluoroethylenepropene copolymer), PFA (perfluoroalkoxyalkane), ETFE (ethylene-tetrafluoroethylene copolymer), ECTFE (ethylene-chlorotrifluoroethylene copolymer), FVDF (polyvinylidene fluoride), PCTFE (polychlorotrifluoroethyne), and TFE/PDD (tetrafluoroethylene-perfluorodimethyldioxol copolymer). From a view point of liquid repellency, it is particularly preferable to use PTFE.

For example, as the electroless plating solution for codepositing PTFE, NIMUFLON (registered trade mark), NIMUFLON FRS, and NIMUFLON-T sold by C. Uyemura & Co., Ltd., Top NICOSITE TF, Top NICOSITE FL, and Top NICOSITE AF sold by Okuno Chemical Industries Co., Ltd., and the like may be used.

Whether an electroplating solution or an electroless plating solution, in the case of plating treatment using supercritical CO₂, since supercritical CO₂ is dissolved in the plating solution, and the pH of the plating solution is sifted to an acidic side, it is preferable to use a plating solution having a high degree of bath stability in an acidic region.

<Surfactant>

A non-polar high pressure fluid such as supercritical carbon dioxide is immiscible with the aforementioned plating solution, and the plating solution is separated from supercritical carbon dioxide. Then, by adding a surfactant, the plating solution is emulsified to be uniform, whereby the reaction efficiency may be improved. As the surfactant, from anionic, nonionic, cationic and amphoteric surfactants which have been previously used, at least one kind may be selected and used. In a combination of the high pressure fluid of a polar substance such as supercritical water and the plating solution of a polar substance, since there is miscibility, it is not necessary to add the surfactant.

Examples of the anionic surfactant are not limited to, but include soap, alphaolefinsulfonate, alkylbenzenesulfonate, alkylsulfate, alkylether sulfate, phenylether sulfate, salt of methyl taurine acid, sulfosuccinate, ethersulfonate, sulfonated oil, phosphate, perfluoroolefinsulfonate, perfluoroalkylbenzenesulfonate, perfluoroalkylsulfate, perfluoroalkylethersulfate, perfluorophenylethersulfate, salt of perfluoromethyl taurine acid, sulfoperfluorosuccinate, and perfluoroethersulfonate.

Examples of a cation of a salt of the anionic surfactant are not limited to, but include sodium, potassium, calcium, tetraethylammonium, triethylmethylammonium, diethyldimethylammonium, and tetramethylammonium, and cations capable of being electrolyzed may be used.

Examples of the nonionic surfactant are not limited to, but include C1-25 alkylphenol system, C1-20 alkanol, polyalkylene glycol system, alkylolamide system, C1-22 fatty acid ester system, C-22 aliphatic amine, alkylamine ethylene oxide adduct, arylalkylphenol, C1-25 alkylnaphthol, C1-25 alkoxylated phosphoric acid (salt), sorbitan ester, styrenated phenol, alkylamine ethylene oxide/propylene oxide adduct, alkylamine oxide, C1-25 alkoxylated phosphoric acid (salt), perfluorononylphenol system, perfluoro higher alcohol system, perfluoropolyalkylene glycol system, perfluoroalkylolamide system, perfluorofatty acid ester system, perfluoroalkylamine ethylene oxide adduct, perfluoroalkylamine ethylene oxide/perfluoropropylene oxide adduct, and perfluoroalkylamine oxide.

Examples of the cationic surfactant are not limited to, but include lauryltrimethylammonium salt, stearyltrimethylammonium salt, lauryldimethylethylammonium salt, dimethylbenzyllaurylammonium salt, cetyldimethylbenzylammonium salt, octadecyldimethylammonium salt, trimethylbenzylammonium salt, hexadecylpyridinium salt, laurylpyridinium salt, dodecylpicolinium salt, stearylamineacetate, laurylamineacetate, octadecylamineacetate, monoalkylammonium chloride, dialkylammonium chloride, ethylene oxide adduct-type ammonium chloride, alkylbenzylammonium chloride, tetramethylammonium chloride, trimethylphenylammonium chloride, tetrabutylammonium chloride, acetic acid monoalkylammonium, imidazoliniumbetaine system, alanine system, alkylbetaine system, monoperfluoroalkylammonium chloride, diperfluoroalkylammonium chloride, perfluoroethylene oxide adduct-type ammonium chloride, perfluoroalkylbenzylammonium chloride, tetraperfluoromethylammonium chloride, triperfluoromethylphenylammonium chloride, tetraperfluorobutylammonium chloride, acetic acid monoperfluoroalkylammonium, and perfluoroalkylbetaine system.

Examples of the amphoteric surfactant include betaine, sulfobetaine, and aminocarboxylic acid, as well as sulfated or sulfonated adduct of a condensation product of ethylene oxide and/or propylene oxide with alkylamine or diamine, being not limiting.

<Plating>

When a body to be plated is plated using the aforementioned plating solution and the high pressure fluid, the electroplating method or the electroless plating method may be selected depending on a material or the like of the body to be plated, and the body may be plated by mixing and stirring the plating solution and the high pressure fluid. For example, the body to be plated is placed into a high pressure container, and then the plating solution with the fine particles and the surfactant added thereto, and the high pressure fluid are mixed and stirred in the closed high pressure container. Thereby, the body to be plated is contacted with the stirred mixed fluid, and a composite plating film is formed on a surface of the body.

The charging ratio of the high pressure fluid and the electrolyte solution in a bath is not particularly limited, but may be appropriately set in view of the concentration of the electrolyte solution, the reaction conditions and so on. However, since when an amount of the electrolyte solution is too small, the reaction becomes difficult to proceed, it is preferable that at least 0.01 wt% or more of the electrolyte solution is contained based on the high pressure fluid at the critical point or lower.

In addition, as an embodiment, for example, when an electroless Ni—P plating film having a thickness of around 1 μm is formed on a whole surface of a 2.0 cm² copper substrate, 30 ml of an electroless Ni—P plating solution, and a surfactant at 0.1 wt % based on the plating solution are added to a 50 ml batch-manner high pressure reactor, supercritical carbon dioxide is introduced into the remaining volume in the reactor, and the mixture is stirred, whereby a plating film may be formed on the copper substrate.

According to such a method, since the plating solution is supplied to detailed position due to the low viscosity and the high diffusivity possessed by the supercritical fluid or the subcritical fluid even when the body to be plated has a fine structure and, at the same time, the fine particles contained in the plating solution are sufficiently diffused, a composite plating film in which the fine particles are uniformly dispersed in a metal matrix may be formed. For this reason, for example, even when the plating film is abraded, the density of the fine particles on a top surface is not changed, and the property possessed by the fine particles is constantly retained. In addition, since the fine particles are uniformly dispersed in the metal matrix, a plating film also having high uniformity in mechanical strength is obtained as compared with a composite configuration in which the fine particles are dispersed unevenly.

Further, since hydrogen generated in a plating step is efficiently removed by the high pressure fluid, formation of a pinhole or a void is suppressed and, at the same time, formation of a nodule is also suppressed, and a composite plating film having an extremely smooth surface is formed.

Then, as a preferable example, a method of forming a liquid repellent composite plating film when an inkjet recording head is manufactured will be specifically explained.

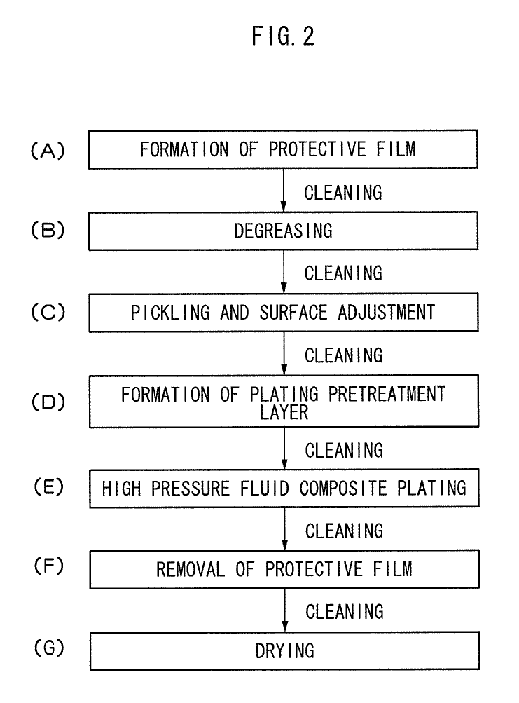

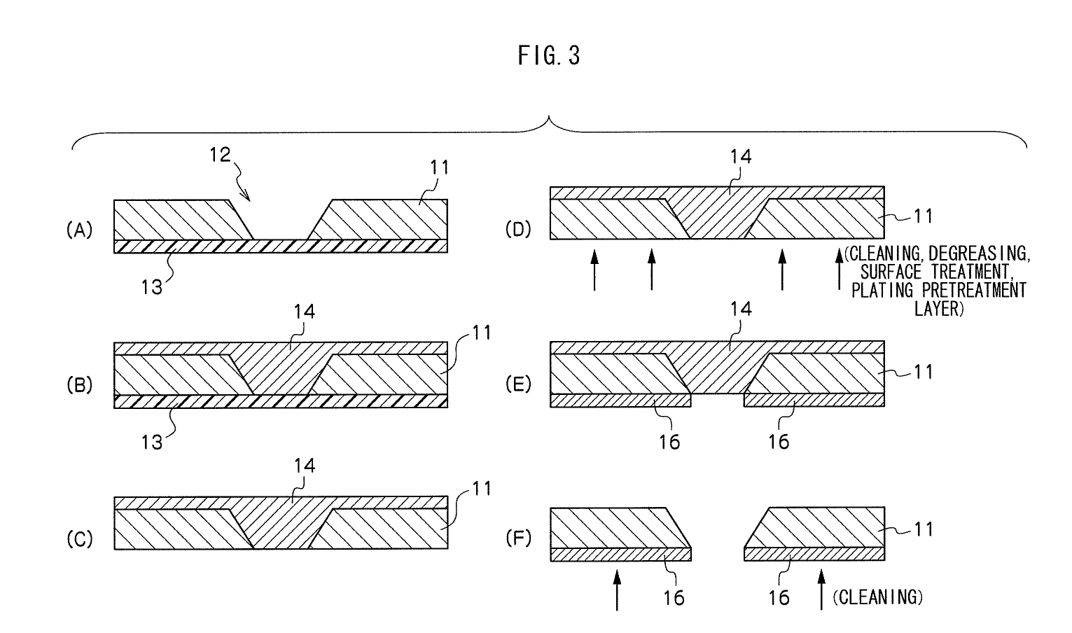

FIG. 2 shows one example of a process of forming a liquid repellent composite plating film on an ink jet surface of a nozzle plate upon manufacturing of the inkjet recording head by the invention. FIG. 3 schematically shows the state of the nozzle plate in each step upon formation of the plating film.

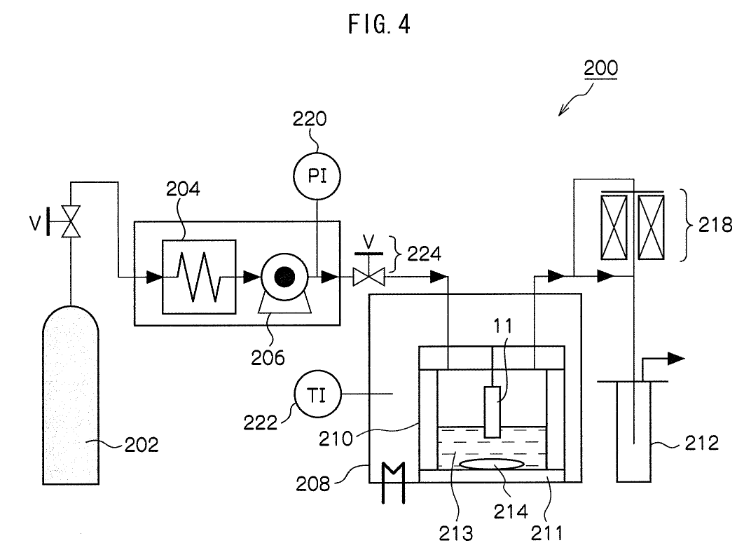

Further, FIG. 4 schematically shows one example of a structure of a supercritical fluid apparatus used in a plating step. This apparatus 200 is provided with a carbon dioxide cylinder 202 for supplying carbon dioxide used as the supercritical fluid, a high pressure reaction container 201 for mixing and stirring the supercritical fluid and a plating solution 213 to plate a nozzle plate 11, a constant temperature bath 208 equipped with a stirring device 211, and a trap 212 for recovering a plating solution.

A process for manufacturing an inkjet recording head according to the invention includes:

forming a protective film 14 for plating on a surface on a side opposite to an ink jet side of the nozzle plate 11 in which a nozzle part 12 for jetting an ink is formed (FIG. 3(A) to (C)),

contacting a mixed fluid obtained by mixing and stirring a first high pressure fluid and a plating solution containing liquid repellent fine particles, with the nozzle plate 11 on which the protecting film 14 for plating is formed, to form a composite plating film 16 on a surface on the ink jet side (FIG. 3 (E)), and

removing the protective film 14 for plating from the nozzle plate 11 on which the composite plating film 16 is formed (FIG. 3(F)).

[Formation of Protective Film for Plating]

First, the nozzle plate 11 in which the nozzle part 12 for jetting an ink has been formed is prepared. As the nozzle plate 11, a nozzle plate made of silicon, ceramics, a resin-based material such as a plastic, or a metal is suitably used.

When a liquid repellent codeposited plating film is formed by electroplating, a plating subject (nozzle plate 11) is required to be electrically conductive, but even when the nozzle plate 11 is made of a material having no electrical conductivity (e.g. ceramics or plastics), electroplating may be performed by forming a seed layer having electrical conductivity in advance by sputtering or electroless plating.

As shown in FIG. 3(A), for example, a plate-like elastic material 13 is pressed and attached to a surface on an ink jet side (ink jet surface) of the nozzle plate 11. As the elastic material 13, an elastic material which is pressed and attached thereto so that a material for forming the protective film 14 for plating (material for protective film) does not leak to the ink jet surface of the nozzle plate 11 later, and which is easily removed after the material for protective film is cured to form a protective film is used.

A material constituting the elastic material 13 is not particularly limited as far as it does not chemically react with the material for a protective film, and may be pressed and bonded to the nozzle plate 11, but examples thereof include a silicone rubber, a fluorine rubber, and a dry film. The shape of the elastic material 13 is not limited to a plate-like shape, but may be selected depending on the shape of the nozzle plate 11 on which the plating film is formed.

Examples of a method of pressing and bonding the elastic material 13 to the nozzle plate 11 include a method of placing the nozzle plate 11 and the elastic material 13 on separate supporting plates made of a metal or the like, superposing the ink jet surface of the nozzle plate 11 and the elastic material 13, and pressing them to each other. Upon pressing, an application of pressure is adjusted so that the material for a protective film which is imparted to the nozzle plate 11 later is not leaked out on the ink jet surface side through the nozzle part 12, to press and bond the nozzle plate 11 and the elastic material 13 to each other.

Then, in order to avoid formation of the plating film on a part other than an ink jet surface of the nozzle plate 11, as shown in FIG. 3(B), the material for a protective film is poured (filled) into the nozzle part 12 in the state where the elastic material 13 is pressed and attached to the ink jet surface of the nozzle plate 11 and, at the same time, a surface on a side to which the elastic material 13 is not adhered is coated with the material for a protective film. A method of imparting the material for a protective film to the nozzle plate is not particularly limited, but may be selected from known methods such as a spin coating method, a roll coating method, a spray coating method, and a dipping method.

After coating, by curing the material for a protective film, the protective film 14 for plating is formed. The means for curing the material for a protective film may be selected depending on a material for a protective film used and, examples thereof include usually heating, light exposure, and drying.

As such a material for a protective film, a material which is inert to a plating step, and is excellent in acid resistance and alkali resistance is preferable. Specifically, examples include a masking material for plating, a representative of which is MASKACE (manufactured by Taiyo Chemical Co., Ltd.).

A further preferable material for a protective film is a material which does not cause a change such as foaming, swelling, peeling and dissolution due to the high pressure fluid used in a plating step etc., is inert to the plating step, and may be easily removed after plating. Examples thereof include a photosensitive liquid resist having polymethylphenylsilane etc. Polymethylphenylsilane is a resist material which is hardly soluble in supercritical CO₂ used in the plating step etc. and, on the other hand, after the plating step, becomes methylsiloxane by ultraviolet irradiation, to be soluble in supercritical CO₂. If the high pressure fluid such as supercritical CO₂ may be used upon removal of the protective film 14 for plating, an organic solvent used at resist removal as previous one is unnecessary, and the amount of a waste solution generated during a process may be reduced.

After formation of the protective film 14 for plating, the elastic material 13 is removed (FIG. 3 (C)). When the elastic material 13 which is pressed and attached to the nozzle plate 11, and does not react with the protective film 14 for plating, such as the aforementioned silicone rubber, fluorine rubber, and dry film is selected, the elastic material 13 may be easily detached from the nozzle plate 11 after formation of the protective film.

[Pretreatment for Plating]

After formation of the protective film for plating, a surface (ink jet surface) of the nozzle plate 11 from which the elastic material 13 has been removed is subjected to pretreatment for plating. Since the pretreatment for plating is different depending on a plating method (electroplating method or electroless plating method) selected in the plating step, and a material of the nozzle plate 11, it may be appropriately selected.

Specifically, examples of the pretreatment for plating include a greasing step which is performed on the ink jet surface of the nozzle plate 11 (FIG. 2(B)), and a pickling and surface adjusting step (FIG. 2(C)). Alternatively, it is also preferable to perform a cleaning step. It is preferable that the cleaning step is appropriately performed without limiting to the pretreatment for plating and, particularly, it is preferable that the cleaning step is performed before at least one step of the degreasing step (FIG. 2(B)), the pickling and surface adjusting step (FIG. 2(C)), the plating step (FIG. 2(E)), and the drying step (FIG. 2(G)).

In the invention, it is essential to use the high pressure fluid in the plating step, and the high pressure fluid may be suitably used in any step of the degreasing step, the pickling and surface adjusting step, the plating step, the drying step, and the cleaning step. Particularly, it is preferable that a step of degreasing with the high pressure fluid and a step of performing pickling and surface adjustment with the high pressure fluid containing an acid, after formation of the protective film for plating, and before the plating step.

In addition, the high pressure fluid used in the plating step (first high pressure fluid), the high pressure fluid used in the degreasing step (second high pressure fluid), the high pressure fluid used in a step of performing pickling and surface adjustment with the high pressure fluid containing an acid (third high pressure fluid), and the high pressure fluid used in the cleaning step (forth high pressure fluid) may be each different kinds, but it is preferable to use the same kind, particularly, supercritical carbon dioxide. For example, as the first high pressure fluid, supercritical carbon dioxide may be used, and as the second, third and fourth high pressure fluids, carbon dioxide, a mixed fluid of carbon dioxide and a surfactant, a mixed fluid of carbon dioxide, water and a surfactant, a mixed fluid of carbon dioxide, water, a surfactant and an acid, or a mixed fluid of carbon dioxide, water, a surfactant and an alkali may be suitably used.

The case where the high pressure fluid is conveniently used in the step other than the plating step will be explained below.

-Degreasing Step-

Upon degreasing in order to remove an oil component etc. adhered to a surface of the nozzle plate 11, when a solvent such as trichloroethylene, tetrachloroethylene, or trichloroethane is used as in the previous degreasing operation, this may cause adverse influence on the environment.

On the other hand, when any of the high pressure fluid such as supercritical carbon dioxide alone, the high pressure fluid+the surfactant, the high pressure fluid+the surfactant+water, the high pressure fluid+water, the high pressure fluid+the surfactant+the acidic solution, or the high pressure fluid+the surfactant+the alkaline solution is used, during a process of raising the temperature and the pressure to the supercritical state or the subcritical state, a surface on which a plating film of the nozzle plate 11 is formed is naturally degreased and cleaned due to a stream generated in the system. Therefore, in the invention, the previous degreasing operation using an organic degreasing agent before the plating step may be omitted, and the environmental preservation type system may be realized.

In this respect, the invention does not exclude the case where the plating subject (nozzle plate 11) is subjected to degreasing and cleaning in advance as in the previous case.

-Step of Performing Pickling and Surface Adjustment with High Pressure Fluid Containing Acid-

In the invention, it is preferable that the surface on which the plating film is formed is further subjected to pickling and surface adjustment with the high pressure fluid containing an acid. By such pickling and surface adjustment using the high pressure fluid containing an acid, an oxide layer formed on a surface of the nozzle plate 11 is removed, and the surface is roughed, whereby adhesion of the plating film formed later may be improved. Particularly, when electroless plating is performed in the plating step, catalyst particles are easily adhered to the surface in a plating pretreatment because of the aforementioned pickling or the like.

For example, a pickling solution to which a surfactant was added, and carbon dioxide in the supercritical state or the subcritical state as the high pressure fluid are mixed and stirred, and emulsified in a high pressure reaction container 210 of a supercritical fluid apparatus 200 having a structure as shown in FIG. 4. This emulsified solution surrounds the nozzle plate 11 and the elastic material 13, and reactant species are efficiently supplied to surfaces of the nozzle plate 11 and the elastic material 13. Thereby, an oxide layer on a surface of the nozzle plate 11 may be removed and, at the same time, the surface of the nozzle plate 11 may be uniformly roughed. In this manner, according to the method using the high pressure fluid containing an acid, since a small amount of a treating solution is sufficient as compared with the previous method of immersing the nozzle plate 11 in the pickling solution, an amount of a waste solution to be treated may be suppressed.

-Cleaning Step-

It is preferable to use the high pressure fluid also in the cleaning step. Cleaning using the high pressure fluid is preferable in that treatment of waste solution generated in a conventional cleaning with a liquid such as a solvent is unnecessary. For example, the nozzle plate 11 in which the protective film 14 for plating is formed as shown in FIG. 3(D) is disposed in a high pressure reaction container 210 of an apparatus 200 having a structure as shown in FIG. 4. And, the interior of the container 210 is set at such a condition (temperature and pressure) that the high pressure fluid (e.g. supercritical carbon dioxide) is generated, to generate the high pressure fluid, and a foreign matter adhered to a surface of a nozzle plate 11 is removed utilizing high diffusivity and solubility of the high pressure fluid. In addition, since by reducing the pressure, or lowering the temperature in the container 210, the high pressure fluid is rapidly vaporized or liquidized, this is collided against the ink jet surface of the nozzle plate 11 with a swift stream, and the surface may be effectively cleaned. In such a cleaning step, for example, any of the high pressure fluid such as carbon supercritical dioxide alone, the high pressure fluid+the surfactant, the high pressure fluid+water, the high pressure fluid+water+the surfactant, or the high pressure fluid+the surfactant+the acidic solution or the alkaline solution may be suitably used.

For example, when the plating step using supercritical carbon dioxide, and the plating pretreatment step such as degreasing and cleaning are sequentially performed, it is preferable to use supercritical carbon dioxide, supercritical carbon dioxide+the additive (surfactant etc.), supercritical carbon dioxide+the surfactant+water, supercritical carbon dioxide+the surfactant+water+acid, or supercritical carbon dioxide+the surfactant+water+the alkali in the plating pretreatment step.

When a foreign matter such as a polar substance is removed by non-polar supercritical carbon dioxide, further cleaning effect may be expected when the additive such as the surfactant is contained.

In addition, regarding the high pressure fluid used in the plating step, from a view point of limitation of usable temperature of the plating solution (for example, a preferable temperature of an electroless Ni—P plating solution is 80° C. to 90° C.), environmental adaptation, and non-toxicity, use of the supercritical fluid of carbon dioxide is preferable. Regarding degreasing, pickling, surface adjustment, activation and cleaning, since there is smaller limitation of a usable temperature of a liquid which is emulsified with the supercritical fluid as compared with the plating step, the high pressure fluid other than carbon dioxide, such as the aforementioned water and ethanol may be used.

As described above, since any of the step of degreasing, the step of performing pickling and surface adjustment with the high pressure fluid containing an acidic solution, and the cleaning step may be performed using the high pressure fluid such as supercritical carbon dioxide, these steps may be continuously performed by circulating carbon dioxide in the supercritical state or the subcritical state at the high speed using the apparatus 200 having a structure as shown in FIG. 4. According to such a method, the high pressure fluid is moved at the high speed and smoothly without forming a Karman vortex as in the cleaning method of only introducing a degreasing fluid or a cleaning fluid into a plating bath, and contacted with a body to be plated (nozzle plate 11) at a constant speed, whereby degreasing and cleaning are performed, and the high speed and precise cleaning action is attained. For example, when the high pressure fluid is adjusted so as to move parallel along the nozzle plate 11, the high speed and precise cleaning action may be maintained without reducing the moving speed and the diffusion rate.

-Formation Step of Plating Pretreatment Layer-

In order to form the plating film on the nozzle plate 11 by an electroless plating method, it is necessary to form a plating pretreatment layer on a surface from which the elastic material has been removed, that is, the ink jet surface on which the plating film is to be formed. This is performed, for examples, as follows.

First, the required amount of a predetermined surfactant is added to a palladium-based catalyst solution to prepare a predetermined composition, and this catalyst solution and the high pressure fluid are stirred and emulsified in the reaction container. A solution stirred in the reaction container surrounds the nozzle plate 11, and catalyst particles are uniformly contacted with the nozzle plate 11. Thereby, on the ink jet surface of the nozzle plate 11, the plating pretreatment layer with catalyst particles adhered thereto is formed. In addition, since the catalyst particles are efficiently supplied to the nozzle plate 11 due to emulsification, the plating pretreatment layer may be formed with a very small amount as compared with the conventional method of immersing the plate in the catalyst solution.

On the other hand, when a plating film is formed on the nozzle plate 11 made of a material having no electrical conductivity by an electroplating method, it is necessary to form a seed layer having electrical conductivity as the plating pretreatment layer on the ink jet surface of the nozzle plate 11 on which the plating film is to be formed. In order to form such an electrically conductive seed layer, a dry process such as deposition, sputtering, CVD (Chemical Vapor Deposition), ALD (Atomic Layer Deposition), and CFD (Chemical Fluid Deposition) using the high pressure fluid, or a wet process such as usual electroless plating, and electroless plating using the high pressure fluid described later may be applied.

[Plating]

The plating step may be performed by an electroplating method or an electroless plating method. The case where a composite plating film is formed by the electroless plating method using supercritical carbon dioxide as the high pressure fluid will be mainly explained below.

-Electroless Plating Step-

The electroless plating refers to a liquid phase thin film forming method of precipitating a metal by an oxidation-reduction reaction using a solution containing a metal ion to be precipitated as the plating film. When the electroless plating step is performed in the invention, for example, a supercritical fluid apparatus 200 manufactured by JASCO Corporation and having a structure as shown in FIG. 4 may be used.

The high pressure reaction container 210 is provided in the constant temperature bath 208 provided with a thermometer 222, and is set at a suitable temperature depending on the plating solution used. Upon plating, it is preferable to set at a temperature at which a substance used as the high pressure fluid is brought into the supercritical state or the subcritical state, or higher.

Carbon dioxide supplied from a carbon dioxide cylinder 202 is cooled with a cooler 204, and a valve 224 is released, whereby carbon dioxide is introduced into the high pressure reaction container 210 while the pressure is controlled with a high pressure pump 206 provided with a manometer 220. The pressure in the high pressure reaction container 210 may be controlled at the predetermined value also by a back pressure adjuster 218. In addition, carbon dioxide, the plating solution, and the surfactant which are discharged at back pressure adjustment are recovered in a trap 212.

When electroless plating is performed on the nozzle plate 11 using the apparatus 200 having such a structure, first, an electroless plating solution 213, a stirrer 214 coated with TEFLON (registered trade mark), and the nozzle plate 11 which has been subjected to pretreatment for electroless plating (FIG. 2(B) to (D)) are placed into the high pressure reaction container 210, and the container is closed. As the electroless plating solution 213, a codeposition electroless plating solution with a liquid repellent resin-a metal to which the predetermined amount of a surfactant having a carbon dioxide-philic group (an affinity part for carbon dioxide) and a hydrophilic group has been added, is used. The use amount of the surfactant is not particularly limited, but usually, about 0.0001 to 30 wt % is preferable, and 0.001 to 10 wt % is particularly preferable, based on the electrolyte solution.

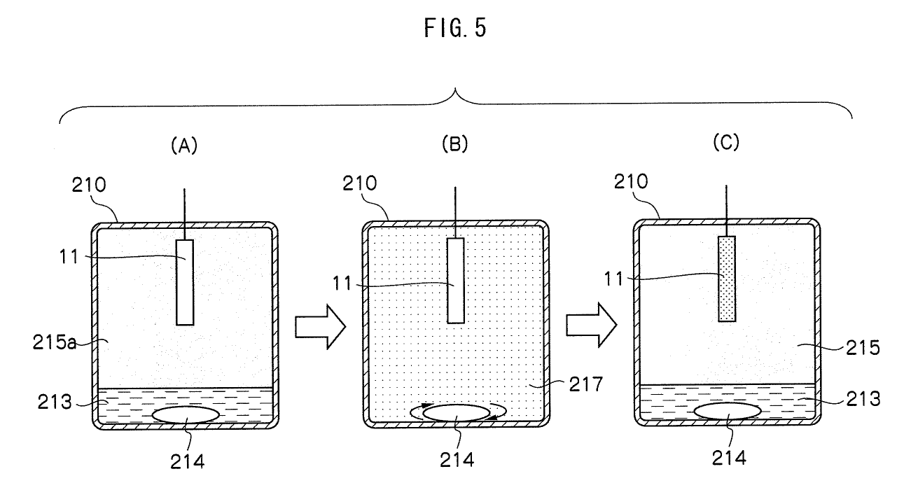

Then, carbon dioxide 215 having the purity of 99.99% or more is introduced into the high pressure reaction container 210 by means of the high pressure pump 206. Thereupon, as shown in FIG. 5(A), the electroless plating solution 213 and supercritical carbon dioxide 215a are still in the separated state.

After carbon dioxide 215 is introduced into the high pressure reaction container 210, a stirring device 211 is driven to rotate the stirrer 214. The pressure in the reaction container 210 at that time is 7.387 MPa which is the critical pressure of carbon dioxide, or higher, and is set in the range of preferably 7.387 MPa or higher and 40.387 MPa or lower, more preferably 10 MPa or higher and 20 MPa or lower. And, the reaction temperature is 304.5 K which is the critical temperature of carbon dioxide, or higher, and is set in the range of preferably 304.5 K or higher and 573.2 K or lower, more preferably 304.5 K or higher, and 473.2 K or lower. And, the reaction time may be determined depending on the target thickness of the plating film, and is usually appropriately set at the time of about 0.001 second to a few months.

As shown in FIG. 5(B), in the reaction container 210, supercritical carbon dioxide 215a, and the electroless plating solution 213 with the liquid repellent resin fine particles and the surfactant added thereto are stirred by the stirrer 214, and the system is brought into the state where the nozzle plate 11 is covered with the emulsified mixed fluid 217. That is, by stirring and mixing of the plating solution containing the surfactant and the liquid repellent resin fine particles, and the high pressure fluid having the high diffusion constant to emulsify them, a bath is homogenized, and the liquid repellent resin fine particles are uniformly dispersed in the plating solution. Thereby, the plating metal ion and the liquid repellent resin fine particles are uniformly supplied to a surface (ink jet surface) of the nozzle plate 11, and are codeposited, and a composite plating film 16 in which the liquid repellent resin is uniformly dispersed in the plating metal matrix, is formed (FIG. 3(E)).

By such an electroless plating using the high pressure fluid, a composite configuration of the metal and the liquid repellent resin is three-dimensionally uniformly dispersed in the direction of the plating film thickness and the direction vertical thereto (plane direction), thereby, even when the plating film is gradually worn out due to wiping, the liquid repellent resin is uniformly present on a top surface, and liquid repellency of the plating film is usually maintained in a constant state.

In addition, by uniformly dispersing the liquid repellent resin in the metal matrix as compared with a conventional composite configuration in which the liquid repellent resin is non-uniformly dispersed in the metal matrix, the plating film uniform also in mechanical strength is obtained.

Further, since hydrogen is generated in the plating reaction, usually, a pinhole and a void due to hydrogen are generated in the plating film, but in the invention, by using the high pressure fluid of carbon dioxide having high compatibility particularly with hydrogen, the hydrogen may be instantly removed, and occurrence of a pinhole and a void may be suppressed.

In addition, in the conventional electroless plating, when palladium fine particles are adhered to the nozzle plate 11 as pretreatment, and electroless plating is performed, the plating film is grown first at the surrounding of the palladium fine particles, the surface roughness is increased with increase in the plating time, and a nodule is easily generated, but in the plating method using the high pressure fluid according to the invention, influence of the plating pretreatment step influencing on the aforementioned surface roughness of the plating film and formation of a nodule is reduced. For this reason, smoothness of the plating film surface is improved, and occurrence of a nodule is also suppressed.

After the predetermined reaction time, stirring is stopped, and the pressure in the reaction container is lowered to the atmospheric pressure. Thereupon, as shown in FIG. 5(C), carbon dioxide 215 and the electroless plating solution 213 are separated again. Then, the nozzle plate 11 is taken out from the reaction container 210, and cleaned. Also in this cleaning, it is preferable to remove the electroless plating solution remaining on a surface of the nozzle plate 11 using the high pressure fluid (supercritical carbon dioxide) as in the aforementioned cleaning step.

[Removal of Protective Film]

Then, the protective film 14 for plating is removed using an organic solvent such as acetone, or the high pressure fluid (FIG. 3(F)). For example, when MASKACE (Taiyo Chemical Co., Ltd., trade name) is used as the protective film 14, the film may be removed by means of toluene. On the other hand, when the protective film 14 is formed of a resist material containing polymethylphenylsilane, the film may be removed by means of supercritical carbon dioxide after the film is brought into the state where it is soluble in supercritical carbon dioxide by ultraviolet exposure. In this manner, when the protective film may be removed using the high pressure fluid, this is more preferable in that the organic solvent such as acetone is not used, and the amount of waste solution treatment is reduced.

[Drying]

After removal of the protective film 14 from the nozzle plate 11, cleaning is performed, if necessary, followed by drying. Also in such a step of drying the plating film 16 after formation of the liquid repellent plating film 16, it is preferable to clean the plating film surface by use of the high pressure fluid such as supercritical carbon dioxide, followed by drying. Alternatively, after cleaning and drying of the nozzle plate 11, the protective film 14 may be removed.

Via the aforementioned steps, the nozzle plate 11 in which the liquid repellent composite plating film 16 is formed on the ink jet surface may be obtained.

By performing composite plating (electroplating method or electroless plating method) using the supercritical fluid or the subcritical fluid in this manner, the plating film 16 formed on the ink jet surface of the nozzle plate 11 becomes the liquid repellent composite plating film 16 in which the liquid repellent resin is uniformly dispersed in the metal matrix. By formation of the composite plating film 16 in which the composite configuration of the metal and the liquid repellent resin is uniformly dispersed in the direction of the film thickness and the direction vertical thereto (three-dimensionally), the liquid repellent resin is uniformly present on a surface even after wearing of the plating film due to wiping, and liquid repellency of the plating film 16 is constantly maintained.

In addition, by using the high pressure fluid of carbon dioxide having the high compatibility particularly with hydrogen according to the invention, an extremely smooth composite plating film in which occurrence of a pinhole, a void, and a nodule being a problem in the conventional plating method is reduced, may be formed. Particularly, when plating is performed by the electroless plating method using the high pressure liquid, influence on a surface condition (surface roughness etc.) of the plating film due to the plating pretreatment step may be reduced.

In addition, by uniformly dispersing the liquid repellent resin in the metal matrix as compared with the conventional composite configuration in which the liquid repellent resin is unevenly dispersed in the metal matrix, the plating film also having the high uniformity in mechanical strength may be formed.

Therefore, according to the method of the invention, the inkjet recording head having the remarkably improved adhesion of the composite plating film, wiping resistance, ink resistance and jetting stability than the conventional head may be manufactured.

As described above, the invention was explained, but the invention is not limited to the above embodiments.

The body to be plated is not limited to the nozzle plate of the inkjet recording head, but for example, the invention may be also suitably applied to plating of a microdevice.

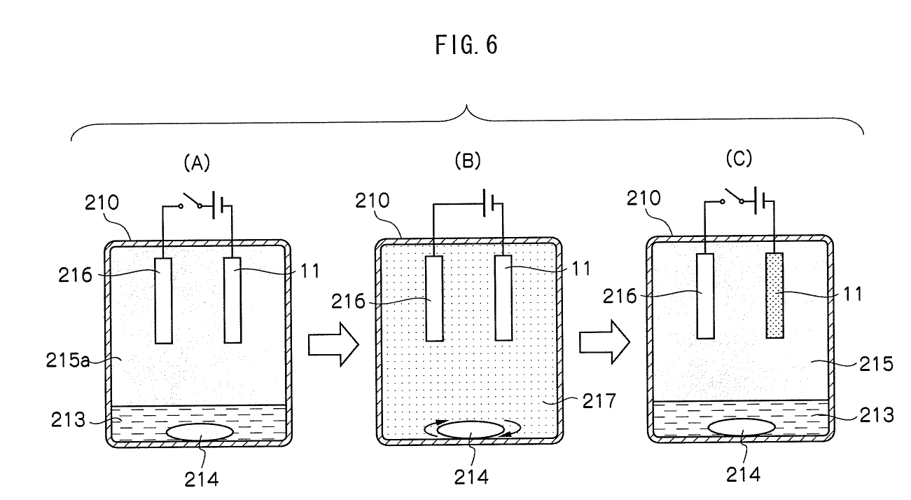

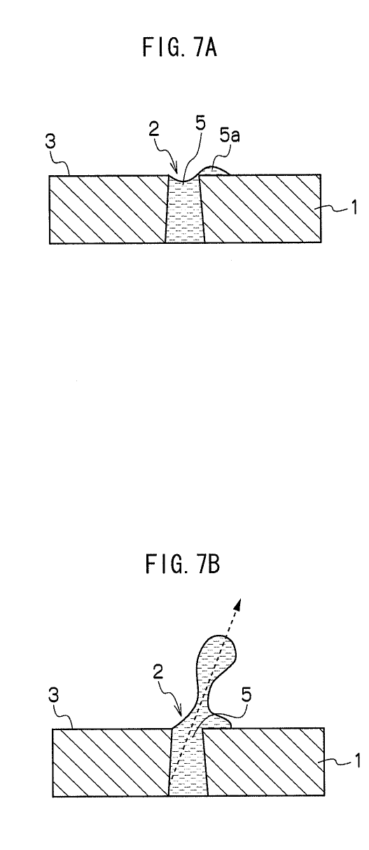

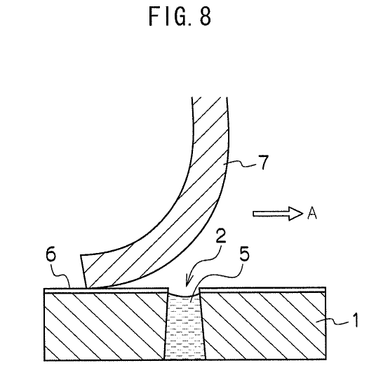

In addition, for example, when the plating film is formed by electroplating, as shown in FIG. 6, an aqueous solution (plating solution) 213 containing a salt containing a metal constituting a composite plating film, fine particles, and a surfactant is put into the reaction container 210 and the nozzle plate 11 is used as a cathode, and a metal which is to be a metal matrix of the composite plating film, or an insoluble electrode (graphite etc.) is used as an anode 216. And, as the high pressure fluid, for example, supercritical carbon dioxide 215a is introduced into the reaction container 210 and the stirrer 214 is rotated to stir the mixture. And, by performing electrolysis at the low current by connecting both electrodes in the direct current, a composite plating film in which fine particles are uniformly dispersed may be formed on the ink jet surface of the nozzle plate 11.

In addition, since each step from the plating pretreatment step to the drying step (FIG. 2(B) to (G)), not limiting to the plating step, may be performed using the high pressure fluid including supercritical carbon dioxide, for example, by a closed system provided with the supercritical fluid apparatus 200 as shown in FIG. 4, waste solution treatment may be reduced, and formation of the composite plating film or manufacture of the inkjet recording head may be performed at the low cost.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for forming a composite plating film, comprising: contacting a mixed fluid obtained by mixing and stirring a high pressure fluid and a plating solution containing fine particles, with a body to be plated to form a composite plating film.

2. A process for manufacturing an inkjet recording head, comprising:
forming a protective film for plating on a surface on a side opposite to an ink jet side of a nozzle plate in which a nozzle part for jetting an ink has been formed,
contacting a mixed fluid obtained by mixing and stirring a first high pressure fluid and a plating solution containing liquid repellent fine particles with the nozzle plate on which the protective film for plating is formed to form a composite plating film on a surface on the ink jet side, and
removing the protective film for plating from the nozzle plate on which the composite plating film is formed.

3. The process for manufacturing an inkjet recording head of claim 2, wherein the liquid repellent fine particles are fluorine-based resin fine particles.

4. The process for manufacturing an inkjet recording head of claim 2, wherein the plating solution contains a surfactant.

5. The process for manufacturing an inkjet recording head of claim 2, wherein the first high pressure fluid contains a supercritical fluid of carbon dioxide.

6. The process for manufacturing an inkjet recording head of claim 2, wherein the plating is performed by an electroplating method or an electroless plating method.

7. The process for manufacturing an inkjet recording head of claim 2, further comprising: degreasing with a second high pressure fluid, and performing pickling and surface adjustment with a third high pressure fluid containing an acid on the nozzle plate after the forming of the protective film, and before the plating.

8. The process for manufacturing an inkjet recording head of claim 2, further comprising: drying the nozzle plate after the removing of the protective film.

9. The process for manufacturing an inkjet recording head of claim 7, further comprising: drying the nozzle plate after the removing of the protective film.

10. The process for manufacturing an inkjet recording head of claim 9, further comprising: cleaning with a fourth high pressure fluid before at least one of the degreasing, the pickling and surface adjustment, the plating, or the drying.

11. The process for manufacturing an inkjet recording head of claim 10, wherein the second, third, and fourth high pressure fluids are carbon dioxide, a mixed fluid of carbon dioxide and a surfactant, a mixed fluid of carbon dioxide, water and a surfactant, a mixed fluid of carbon dioxide, water, a surfactant and an acid, or a mixed fluid of carbon dioxide, water, a surfactant and an alkali.
